(19) United States
(12) Patent Application Publication
(10) Pub. No.: US 2003/0098133 A1
(43) Pub. Date: May 29, 2003

(54) Architectural opening covering having automatic positioning capability

(75) Inventor: Roger C. Palmer, Greensboro, NC (US)

Correspondence Address: James A. Wilke, FOLEY & LARDNER, Firstar Center, 777 East Wisconsin Avenue, Milwaukee, WI, 53202-5367, US

(73) Assignee: Newell Window Furnishings, Inc.

(21) Appl. No.: 09/997,615

(22) Filed: Nov. 29, 2001

(51) Int. Cl. E06B 9/56

(52) U.S. Cl. 160/310; 160/1

(57) ABSTRACT

An automatic positioning system for a covering for an architectural opening is disclosed herein. The system is configured to automatically adjust the position of the covering between a closed position, an open position, and one or more intermediate positions in accordance with a geographic location associated with the architectural opening and the time of day.

### BACKGROUND OF THE INVENTION

The present invention relates generally to coverings for architectural openings. More particularly, the present invention relates to such coverings having automatic positioning capabilities.

Adjustable coverings for architectural openings, such as windows, are commonly used in commercial and residential buildings. Such coverings are provided in front of the windows and are adjustable to several positions relative to the windows. Window coverings can be adjustable between a fully closed or lowered position, a fully open or raised position, and one or more intermediate positions to affect, for example, the light level, temperature, air flow, or privacy within the interior of the building. In addition to raising and lowering vanes or slats of certain window coverings, such as, venetian blinds, vertical blinds and light control blinds can be moved to a light blocking or a light transmitting position. Window coverings can comprise a variety of styles and construction, such as, slats, vanes, louvers, shutters, panels, pleated or cellular shades, etc., oriented in a vertical or horizontal direction.

Presently, window coverings can be configured for manual, remote, and/or automatic operation. A user can manually adjust the window covering to achieve a desirable position relative to the window. Or a window covering may be adjusted remotely or automatically via the use of timers, photosensors, occupant sensors, transmitters/receivers, etc. In particular, it is advantageous to provide for automatic positioning of window coverings. For example, it is advantageous to have automatic nighttime closing of window coverings for privacy, security, and energy conservation reasons. Large buildings, such as commercial buildings, would not have to rely on individual personnel to manually close the window coverings before leaving in the evening. Automatic operation would also enable persons with disabilities, who may not be readily able to manually operate the window coverings, to benefit from position adjustments that are coordinated with changes in the exterior light conditions.

Unfortunately, existing automatic operation schemes suffer from a number of disadvantages. Window coverings with timers need to be repeatedly reset or reprogrammed in accordance with the ever-changing sunrise time, sunset time, daylight savings time, and other exterior light conditions which are not tied to a given time of the day. Window coverings with photosensors are more synchronized with exterior light conditions, but suffer from the inability to distinguish local factors or events (e.g., trees, telephone poles, intermittent cloud coverage, etc. which may be proximate and affecting one or more photosensors) from overall exterior light conditions. Hence, there may be unnecessary and undesirable variation in position between window coverings in the same building, or same area of the building (e.g., some window coverings may be in the open position while others are in the closed position although all of the window coverings are being subject to the same overall exterior light conditions), and/or unnecessary number of adjustments within a relatively short time period.

Thus, there is a need for an apparatus and method configured to provide automatic adjustments to the position of window coverings within a dwelling, or a specified area within the dwelling, in accordance with the geographic location of the dwelling. There is a further need for an apparatus and method that permits an user of the window coverings to specify the position adjustment guidelines or protocol before, during, or after installation of the window coverings. There is a still further need for an apparatus and method that coordinates the actions of all the window coverings within the specified area.

### SUMMARY OF THE INVENTION

One embodiment of the invention relates to a system for automatically positioning a covering associated with an architectural opening of a building. The system includes a biasing unit coupled to the covering. The system further includes a control unit in communication with the biasing unit, and configured to actuate the biasing unit to achieve the automatic position of the covering. A geographic location of the building and a time of day determines the automatic position of the covering. Another embodiment provides that the geographic location is at least one of a latitude, a longitude, a nearest populated area, an address, a zip code, and a global positioning satellite (GPS) location associated with the building and the time of day is local time.

There is also provided a window covering comprising a headrail, a bottom rail, a window covering material coupled to the headrail and bottom rail and a position adjustment mechanism. The position adjustment mechanism comprises a motor unit operatively coupled to the window covering material and a controlled unit in communication with the motor unit and configured to actuate the motor unit to achieve the automatic position of the covering. A geographic location of the building and a time of day determines the automatic position of the window covering.

There is also provided a system for automatically positioning a covering material associated with an architectural opening of a building. The system for automatically positioning comprises a means for moving coupled to the covering material and a means for controlling in communication with the means for moving and configured to actuate the means for moving to achieve the automatic position of the covering material. A geographic location of the dwelling and a time of day determines the automatic position of the covering material.

There is also provided a method for positioning a window covering associated with an architectural opening of a building. The window covering includes a headrail, a bottom rail and window covering material and a position adjustment mechanism. The position adjustment mechanism has a motor unit coupled to the window covering material and a control unit having a user interface and an internal clock. The control unit is in communication with the motor unit and configured to actuate the motor unit. The method comprises the steps of inputting geographic location of the window covering into the control unit. Also, inputting local time of day into the control unit. A first position for the window covering in inputted into the control unit as well as a first time of day to move the window covering to the first position. There is also inputted a second position for the window covering as well as a second time of day to move the window covering to the second position. Then the internal clock of the control unit is activated wherein a sequence of moving the window covering between the two positions will commence.

### BRIEF DESCRIPTION OF THE DRAWINGS

The exemplary embodiments will become more fully understood from the following detailed description, taken in conjunction with the accompanying drawings, wherein like reference numerals denote like elements, in which:

FIG. 1 is a schematic illustration of a building with several architectural openings, with each architectural opening having a window covering with an exemplary embodiment of a position adjustment mechanism.

FIG. 2 is a simplified schematic drawing of a window covering with an automatic position adjustment system.

### DETAILED DESCRIPTION OF THE EXEMPLARY EMBODIMENTS

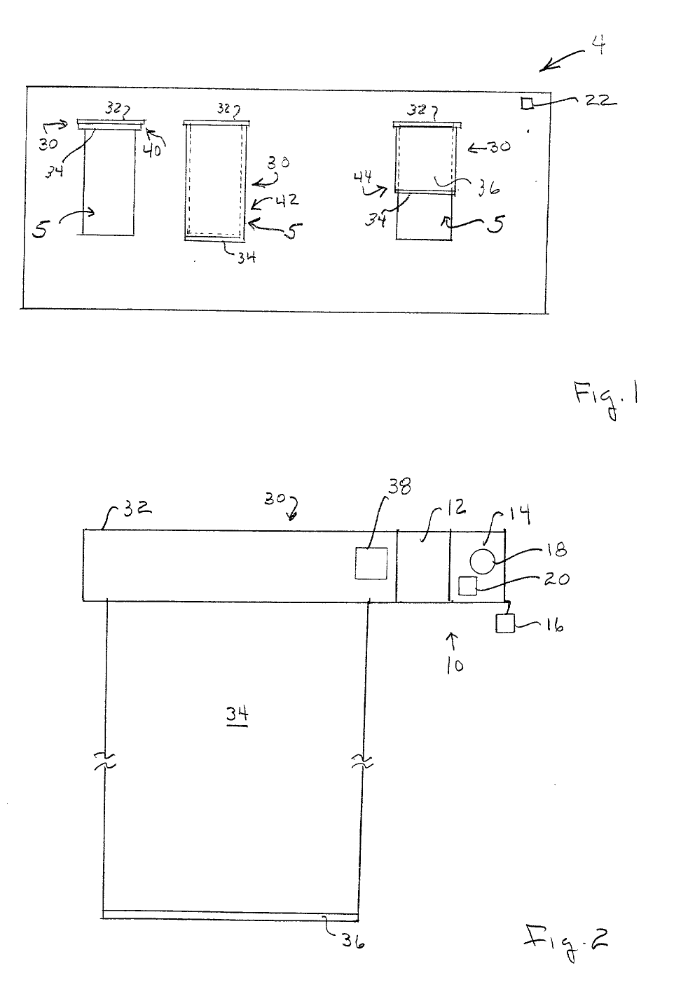

Referring to FIG. 1, there is shown an illustration of a building 4 having a plurality of architectural openings 5. The specific architectural opening illustrated is a window, however, it should be understood that other types of architectural openings are contemplated, for example, a patio door, a casement window, a double hung window, a picture window, or the like. Each of the architectural openings 5 has an individual window covering 30 associated with it. The illustrated architectural openings 5 depict the window covering 30 in a raised position 40, a lowered position 42 and an intermediate position 44. It should be understood that the intermediate position 44 can be any infinite distance between the raised position 40 and the lowered position 42 of a given window covering 30. It should also be understood that the intermediate position is selected by the operator as will be described below.

Referring to FIG. 2, there is shown an automatic position adjustment system 10 for a window covering. System 10 is configured to adjust a window covering 30 at one of several positions in accordance with position adjustment guidelines or protocol, to be described hereinafter. System 10 includes a motor unit 12 (also referred to as a biasing unit) and a control unit 14. Window covering 30 includes a head rail 32, a covering 34, a bottom rail or bar 36, and a position adjustment mechanism 38.

The top of covering 34 is connected to mechanism 38 and the bottom of covering 34 is operatively connected to bottom bar 36. Head rail 32 is provided forward of mechanism 38 such that various attachments and mechanical components generally associated with a window covering can be hidden from view. As shown in FIG. 2, mechanism 38 is a roller or roll bar and is connected to motor unit 12.

It should be understood that window covering 30 can be a variety of coverings for architectural openings, such as, but not limited to, a venetian blind, a roller shade, a pleated blind, a shutter, a louvered blind, a cellular covering, and a variety of other coverings with the slats, vanes, shades, panels, etc. comprising covering 34 being oriented in a vertical or horizontal direction. Mechanism 38 can also be a variety of apparatus for positioning all or at least a portion of covering 34, such as, but not limited to, a tilt rod, a control bar rod, a pulley unit, a roller, or other devices. Mechanism 38 is configured to position window covering 30 in a fully open position (e.g., where bottom bar 36 is proximate to head rail 32), a fully closed position (e.g., where bottom bar 36 is distal to head rail 32), or one or more intermediate positions upon actuation of motor unit 12. Mechanism 38 may also be configured to rotate the slots of a venetian blind or the vanes of a vertical blind from a light blocking position to a light transmitting position.

Control unit 14 is in communication with motor unit 12. Although motor unit 12 and control unit 14 are shown external to head rail 32, units 12 and/or 14 can be provided within head rail 32 (i.e., hidden from view). Control unit 14 can be a processor or controller comprised of an analog circuit, a digital circuit, a programmable logic controller (PLC), an application specific integrated circuit (ASIC), a computer, or a variety of other components to receive, transmit, process, and/or direct the control of motor unit 12.

In one embodiment, a building 4, or a specific area of a building, includes a plurality of window coverings, such as, window covering 30. Each of the plurality of window coverings is connected to an automatic position adjustment system, such as, system 10. Control unit 14 associated with one of these window coverings is a master control unit such that the positions of all of the window coverings are coordinated through this master control unit (i.e., all of the remaining control units 14 are considered to be slave units). In another embodiment, the master control unit may be remotely located from all of the window coverings 30 and systems 10. In still another embodiment, each of the plurality of window coverings may function independently of each other.

In any case, in order to facilitate communication among control units 14, communication with a user or person, communication with the environment, or to implement the position adjustment guidelines or protocol, system 10 may further include a user interface 16, a transmitter, a receiver, a transceiver, a global positioning satellite GPS unit 22, an internal clock 18 and calendar 20, a memory or storage device, etc. The user interface 16 can be directly connected, near the control unit 14, as illustrated in FIG. 2 or it can be remotely located. The user interface 16 can be a keypad, a push button, a computer, or the like.

In one embodiment, the position of window covering 30 is determined in accordance with the geographic location of the dwelling, the time of day, and the date or day of the year. Geographic location can be a latitude, a longitude, nearest large city, zip code, address, or exact location using an GPS unit 22. System 10 associated with each of window covering 30 (or just the master unit) can be programmed or instructed with the appropriate geographic location at the manufacturing facility or store, by the user after purchase or installation via an user interface, or just prior to use via the GPS unit 22.

In operation, an operator would utilize a method for positioning a window covering 30 associated with an architectural opening 5 of a building 4 by implementing the following steps. The operator would input the geographic location of the window covering 30 into the control unit 14 and input the local time of day and date into the control unit 14. In addition, the operator would input a first position for the window opening and a first time of day to move the window covering 30 to the first position. The operator would also input a second position for the window covering and input a second time of day to move the window covering 30 to the second position. The operator would then activate the internal clock 18 in the control unit 14 wherein a sequence of moving the window covering between the positions will commence. Local time shall mean the time of day in a specific time zone and shall conform to local legislation concerning “daylight savings time,” local customs and conventions concerning a twelve hour (a.m./p.m.) clock and a twenty-four hour clock (sometimes referred to as “military time”).

As discussed, several window coverings 30 can be associated with a single control unit 14 or each individual window covering 30 can be operated independently. Additional intermediate positions can be inputted into the control unit 14 for the specific window covering 30 and inputting a third time of day to move the window covering 30 to the intermediate position. As will be discussed below, additional data can be inputted into the control unit. Such data is associated with the geographic location of the window covering and includes at least one of climate information, temperature information, daily sunset time, daily sunrise time, daily sunlight information and data relating to daylight savings time changes. In addition to the initial inputting of data into the control unit, the operator can also modify the data associated with the geographic location with the user preference to determine the position of the window covering. In other words, a user preference can be something other than that based on time of day, climate conditions, or temperatures.

Once a geographic location has been identified, sunrise and sunset times, typical climate, sunlight or cloud conditions, temperature, etc. for each day of the year associated with that location can be utilized with the internal clock 18 and calendar 20 information to appropriately position window covering 30 during the course of a given day and throughout the year. Hence, for example, on days when the temperature is likely to be high (e.g., during the summer season), window covering 30 may be provided at a closed or near closed position even when it is daylight hours in order to facilitate a comfortable interior temperature.

In another embodiment, the direction that each of window covering 30 is facing (e.g., north, south, east, or west) may also be identified by system 10. Such identification by or input into system 10 can be provided, for example, by the user around the time of installation of each of window covering 30. Such information would further facilitate automatic positioning of each of window covering 30 to achieve desirable light level, temperature, air flow, or privacy.

In still another embodiment, system 10 may maintain a log or store data relating to the position of window covering 30 with the associated time and date, as specified by the user (e.g., either by manual operation of mechanism 38 or by inputs to the user interface 16). A number of such data points, especially over a certain time period, permits system 10 to “learn” the actual routine and preferences of the user. Such data combined with the information obtainable upon identification of a geographic location results in a highly intelligent system 10.

In yet still another embodiment, system 10 may utilize its internal clock 18 and calendar 20 along with, at least, known sunset and sunrise times for each day of the year, to automatically position window covering 30. For example, the window covering material will be in a raised and lowered position a certain amount of time before or after sunrise or sunset. If a user indicates that it wishes the window covering to be raised ten minutes before sunrise and lowered ten minutes after sunset the control system would adjust the actual, local time of day the window covering is raised or lowered to correspond to the changing time of sunrise and sunset on a daily basis.

It is contemplated that system 10 for each of window covering 10 (when each of window covering 10 acts independently of each other) or system 10 that is the master unit (when the plurality of window coverings 30 are in a master-slave configuration) can be configured to signal the appropriate motor unit(s) 12 in accordance with the geographic location, magnetic compass direction, actual user preferences, actual time and date, and/or a combination thereof.

It is understood that although the detailed drawings, specific examples, and particular values describe the exemplary embodiments of the present invention, they are for purposes of illustration only. The exemplary embodiments of the present invention are not limited to the precise details and descriptions described herein. For example, although certain devices or components are mentioned, a variety of other devices or components having similar functionality can be utilized. Various modifications may be made in the details disclosed without departing from the spirit of the invention as defined in the following claims.

What is claimed is:

1. A system for automatically positioning a covering associated with an architectural opening of a building, the system comprising:
a biasing unit coupled to the covering; and
a control unit in communication with the biasing unit and configured to actuate the biasing unit to achieve the automatic position of the covering, wherein a geographic location of the building and a time of day determines the automatic position of the covering.

2. The system of claim 1, wherein the geographic location being at least one of a latitude, a longitude, a nearest populated area, an address, a zip code, and a global positioning satellite (GPS) location associated with the building and the time of day is local time.

3. The system of claim 1, wherein the dwelling includes another covering associated with another architectural opening, and the covering and the another covering are both controlled by the control unit.

4. The system of claim 1, wherein the covering is selected from a group including a venetian blind, a roller shade, a pleated blind, a shutter, a vertical blind, and a cellular covering.

5. The system of claim 1, wherein the control unit includes a user interface configured to accept and store a user preference selected from a group including a covering position preference, a time, and a date.

6. The system of claim 5, wherein the control unit modifies data associated with the geographic location with the user preference to determine the automatic position of the covering.

7. The system of claim 1, wherein the control unit includes an internal clock and calendar.

8. The system of claim 1, wherein the control unit includes data associated with the geographic location, the data including at least one of climate information, daily temperature information, daily sunset time, daily sunrise time, and daily sunlight information.

9. The system of claim 1, wherein the system is provided with the geographic location by at least one of a preset at a manufacturing facility of the covering, an input by a user of the covering, and a communication with an GPS system.

10. The system of claim 1, wherein the automatic positioning of the covering is selected from a group including a raised position, a lowered position, an intermediate position, a light transmitting position, and a light blocking position.

11. A window covering comprising:
a headrail;
a bottom rail;
a window covering material coupled to the headrail and the bottom rail; and,
a position adjustment mechanism comprising:
a motor unit operatively coupled to the window covering material; and
a control unit in communication with the motor unit and configured to actuate the motor unit to achieve the automatic position of the covering, wherein a geographic location of the building and a time of day determines the automatic position of the covering.

12. The window covering of claim 11, wherein the geographic location being at least one of a latitude, a longitude, a nearest populated area, an address, a zip code, and a global positioning satellite (GPS) location associated with the building.

13. The window covering of claim 11, wherein a second window covering is associated with the window covering with both window coverings controlled by the control unit.

14. The window covering of claim 11, wherein the window covering material is selected from a group including a venetian blind, a roller shade, a pleated blind, a shutter, a vertical blind, and a cellular covering.

15. The window covering of claim 11, wherein the control unit includes a user interface configured to accept and store a user preference selected from a group including a window covering position preference, a time, and a date.

16. The window covering of claim 15, wherein the control unit modifies data associated with the geographic location with the user preference to determine the automatic position of the window covering material.

17. The window covering of claim 11, wherein the control unit includes an internal clock and calendar.

18. The window covering of claim 11, wherein the control unit includes data associated with the geographic location, the data including at least one of climate information, daily temperature information, daily sunset time, daily sunrise time, and daily sunlight information.

19. The window covering of claim 11, wherein the system is provided with the geographic location by at least one of a preset at a manufacturing facility of the window covering, an input by a user of the covering, and a communication with an GPS system.

20. The window covering of claim 11, wherein the automatic positioning of the window covering material is selected from a group including a raised position, a lowered position, an intermediate position, a light transmitting position and a light blocking position.

21. A system for automatically positioning a covering material associated with an architectural opening of a building, the system comprising:
a means for moving coupled to the covering material; and
a means for controlling in communication with the means for moving and configured to actuate the means for moving to achieve the automatic position of the covering material, wherein a geographic location of the building and a time of day determines the automatic position of the covering material.

22. The system of claim 21, wherein the geographic location being at least one of a latitude, a longitude, a nearest populated area, an address, a zip code, and a global positioning satellite (GPS) location associated with the building and the time of day is local time.

23. The system of claim 21, wherein the building includes another covering material associated with another architectural opening, and the covering material and the another covering material are both controlled by the means for controlling.

24. The system of claim 21, wherein the covering material is selected from a group including a Venetian blind, a roller shade, a pleated blind, a shutter, a vertical blind, and a cellular covering.

25. The system of claim 21, wherein the means for controlling includes a means for interfacing configured to accept and store a user preference selected from a group including a covering material position preference, a time, and a date.

26. The system of claim 25, wherein the means for controlling modifies data associated with the geographic location with the user preference to determine the automatic position of the covering material.

27. The system of claim 21, wherein the means for controlling includes an internal clock and calendar.

28. The system of claim 21, wherein the means for controlling includes data associated with the geographic location, the data including at least one of climate information, daily temperature information, daily sunset time, daily sunrise time, and daily sunlight information.

29. The system of claim 21, wherein the system is provided with the geographic location by at least one of a preset at a manufacturing facility of the system, an input by a user of the system, and a communication with an GPS system.

30. The system of claim 21, wherein the automatic positioning of the covering material is selected from a group including a raised position, a lowered position, an intermediate position, a light transmitting position and a light blocking position.

31. A method for positioning a window covering associated with an architectural opening of a building, the window covering having a headrail, a bottom rail, a window covering material and a position adjustment mechanism, with the position adjustment mechanism having a motor unit coupled to the window covering material and a control unit having an user interface and an internal clock with the control unit in communication with the motor unit configured to actuate the motor unit, the method comprising the steps of:
inputting geographic location of the window covering into the control unit;
inputting local time of day into the control unit;
inputting a first position for the window covering;
inputting a first time of day to move the window covering to the first position;
inputting a second position for the window covering;
inputting a second time of day to move the window covering to the second position; and,
activating the internal clock in the control unit wherein a sequence of moving the window covering between the two positions will commence.

32. The method for positioning a window covering of claim 31, wherein the geographic location being at least one of a latitude, a longitude, a nearest populated area, an address, a zip code, and a global positioning satellite (GPS) location associated with the building.

33. The method for positioning a window covering of claim 31, including the steps of: inputting an intermediate position for the window covering; and, inputting a third time of day to move the window covering to the intermediate position.

34. The method for positioning a window covering of claim 31, including the step of inputting data associated with the geographic location of the window covering into the control unit, the data including at least one of climate information, daily temperature information, daily sunset time, daily sunrise time, and daily sunlight information.

35. The method for positioning a window covering of claim 34, including the step of modifying, in the control unit, the data associated with the geographic location with a user preference to determine the position of the window covering.

36. The method for positioning a window covering of claim 31, including the step of controlling at least one additional window covering associated with another architectural opening in the building with the control unit.
